(19) United States
(12) Patent Application Publication
(10) Pub. No.: US 2016/0067910 A1
(43) Pub. Date: Mar. 10, 2016

(54) TEMPLATE, TEMPLATE MANUFACTURING METHOD, AND IMPRINTING METHOD

(71) Applicant: KABUSHIKI KAISHA TOSHIBA, Tokyo (JP)

(72) Inventor: Masato SUZUKI, Yokohama (JP)

(21) Appl. No.: 14/636,424

(22) Filed: Mar. 3, 2015

(30) Foreign Application Priority Data
Sep. 8, 2014 (JP) 2014-182197

(51) Int. Cl. B29C 59/16; B29C 59/00

(52) U.S. Cl. CPC B29C 59/16; B29C 59/002; B29L 2031/757

(57) ABSTRACT

According to one embodiment, a pattern region for a device and a mark region are provided on one and the same surface of a substrate. First concave portions are provided in the pattern region, and second concave portions are provided in the mark region. Embedded in the substrate are alignment marks opposed to bottom surfaces of the second concave portions.

### CROSS-REFERENCE TO RELATED APPLICATIONS

This application is based upon and claims the benefit of priority from Japanese Patent Application No. 2014-182197, filed on Sep. 8, 2014; the entire contents of which are incorporated herein by reference.

### FIELD

Embodiments described herein relate generally to a template, template manufacturing method, and imprinting method.

### BACKGROUND

For alignment of a template in nano-imprinting, a light-absorbing layer is embedded in the template so that the position of the template can be identified at filling of a resist.

### BRIEF DESCRIPTION OF THE DRAWINGS

FIGS. 1A to 1E are cross-sectional diagrams illustrating an imprinting method using a template according to a first embodiment;

FIGS. 2A to 2J are cross-sectional diagrams illustrating a template manufacturing method according to a second embodiment;

FIGS. 3A to 3I are cross-sectional diagrams illustrating a template manufacturing method according to a third embodiment;

FIGS. 4A to 4F are cross-sectional diagrams illustrating a template manufacturing method according to a fourth embodiment;

FIGS. 5A to 5H are cross-sectional diagrams illustrating a template manufacturing method according to a fifth embodiment; and

FIGS. 6A to 6F are cross-sectional diagrams illustrating a template manufacturing method according to a sixth embodiment.

### DETAILED DESCRIPTION

According to one embodiment, a pattern region for a device and a mark region are provided on one and the same surface of a substrate. First concave portions are provided in the pattern region, and second concave portions are provided in the mark region. Embedded in the substrate are alignment marks opposed to bottom surfaces of the second concave portions.

Exemplary embodiments of a template, template manufacturing method, and imprinting method will be explained below in detail with reference to the accompanying drawings. The present invention is not limited to the following embodiments.

### First Embodiment

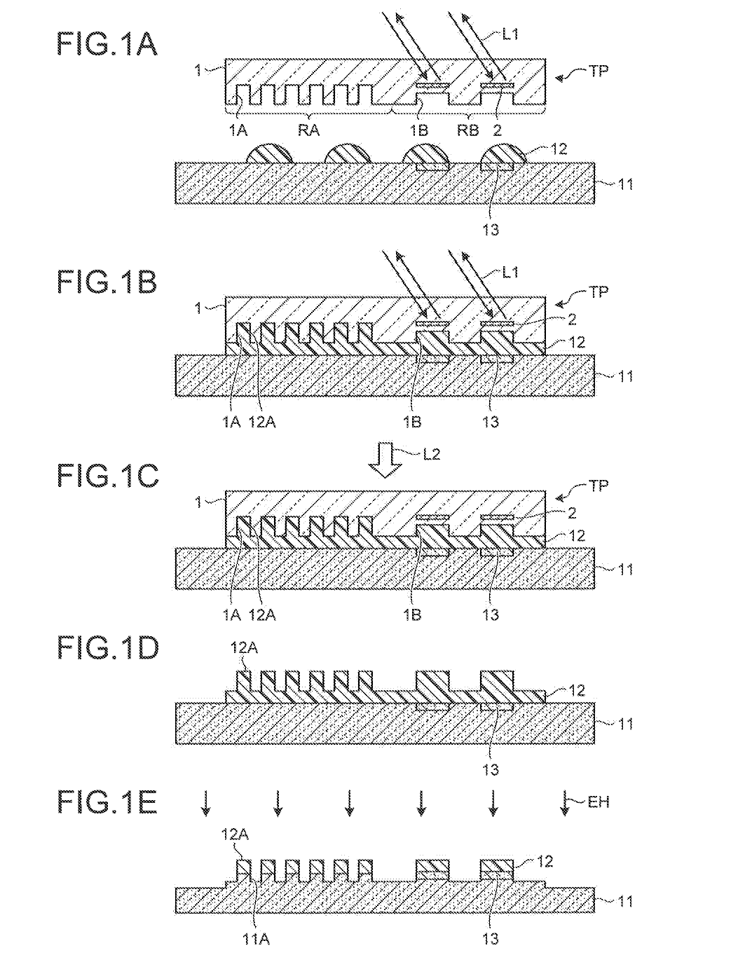

FIGS. 1A to 1E are cross-sectional diagrams illustrating an imprinting method using a template according to a first embodiment.

Referring to FIG. 1A, a template TP includes a device region RA and a mark region RB. The device region (pattern region for a device) RA and the mark region RB are situated on one and the same surface of a substrate 1. The substrate 1 can be made of quartz, for example. Concave portions 1A are provided in the device region RA, and concave portions 1B are provided in the mark region RB. The concave portions 1A can be made finer than the concave portions 1B. For example, the width of the concave portions 1A and the space between the same can be set in nanometer order. The concave portions 1A can be deeper than the concave portions 1B. Alignment marks 2 are embedded in a position opposed to a bottom surface of the concave portion 1B in the substrate 1. The alignment marks 2 may be unexposed from the substrate 1. The alignment marks 2 correspond in shape and size to the bottom surface of the concave portions 1B. For example, the alignment marks 2 can be configured to be equal in shape and size to the bottom surfaces of the concave portions 1B. The alignment marks 2 can be configured to be different from the substrate 1 in optical property. The alignment marks 2 may be composed of a light-absorbing layer, a light-scattering layer, or a light-reflecting layer. For example, the alignment marks 2 may use an ion-implanted layer of antimony absorbing light or the like. In the case of using a light-absorbing layer as the alignment marks 2, it is preferred to set a light-absorbing wavelength band in an infrared region of 500 to 800 nm to make a processed layer 11 more visible.

Then, an imprint material 12 is discharged onto the processed layer 11 by using an ink-jet technique or the like. Formed on the processed layer 11 are alignment marks 13 for use in alignment with the template TP. The processed layer 11 may be a semiconductor wafer, a semiconductor layer, a metal layer, or an insulating layer. The imprint material 12 may be an ultraviolet-setting resist, for example.

Detecting alignment lights 11 from the alignment marks 2 makes it possible to identify the position of the template TP and align the template TP with the processed layer 11.

Next, as illustrated in FIG. 1B, the template TP is pressed against the imprint material 12 to fill the imprint material 12 into the concave portions 1A and form an imprint pattern 12A on the processed layer 11. At that time, detecting the alignment lights L1 from the alignment marks 2 makes it possible to identify the position of the template TP and defect any misalignment of the template TP and the processed layer 11. By embedding the alignment marks 2 in a position opposed to a bottom surface of the concave portion 1B in the substrate 1, it is possible to reduce variations in the alignment lights L1 between before and after the filling of the imprint material 12 into the concave portions 1B, This allows final stretch of alignment before the filling of the imprint material 12 into the concave portions 1B, thereby resulting in improved throughput. In addition, this makes it possible to conduct alignment even if the imprint, material 12 sticks to the insides of the concave portions 1B, thereby reducing frequency of cleaning the template TP.

Next, as illustrated in FIG. 1C, while the template TP is pressed and held against the imprint pattern 12A, an ultraviolet ray L2 is irradiated to the imprint pattern 12A through the template TP to harden the imprint pattern 12A. In the example of FIG. 1C, an ultraviolet-setting resist may be used as the imprint material 12 to harden the imprint pattern 12A, or a thermosetting resist may be used instead.

Next, as illustrated in FIG. 1D, when the imprint pattern 12A becomes hard, the template TP is removed from the imprint pattern 12A.

Next, as illustrated in FIG. 1E, etching EH is performed on the processed layer 11 via the imprint pattern 12A to transfer the imprint pattern 12A to the processed layer 11 and form on the processed layer 11 a processed pattern 11A corresponding to the imprint pattern 12A. Then, the imprint pattern 12A left on the processed layer 11 is removed. The processed layer 11 may be subjected to ion implanting, instead of the etching EH.

### Second Embodiment

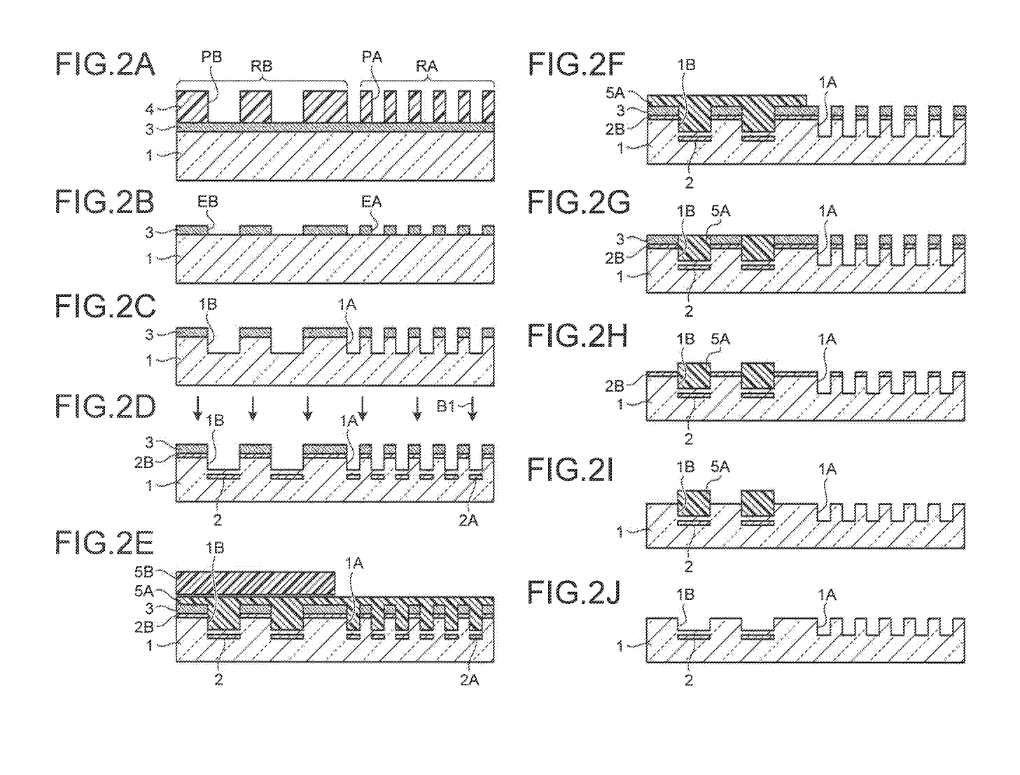

FIGS. 2A to 2J are cross-sectional diagrams illustrating a template manufacturing method according to a second embodiment.

Referring to FIG. 2A, a protective film 3 is formed on the substrate 1 by sputtering, CVD, or the like. The material for the protective film 3 may be CrN or the like, for example. Then, a resist pattern 4 is formed on the protective film 3 by using a photolithography technique. The resist pattern 4 can be provided with openings PA corresponding to the concave portions 1A and openings PB corresponding to the concave portions 1B.

Next, as illustrated in FIG. 2B, the protective film 3 is etched via the resist pattern 4 to transfer the resist pattern 4 to the protective film 3 and form on the protective film 3 openings EA and EB corresponding to the openings PA and PB, respectively.

Next, as illustrated in FIG. 2C, the substrate 1 is etched via the protective film 3 to form on the substrate 1 the concave portions 1A and 1B corresponding to the openings EA and EB, respectively.

Next, as illustrated in FIG. 2D, ion implantation B1 of antimony or the like is performed on the entire substrate 1 to embed the alignment marks 2 arranged under the concave portions 1B into the substrate 1. At that time, an ion-implanted layer 2A is formed in the substrate 1 under the concave portions 1A. In addition, an ion-implanted layer 2B is formed on the surface of the substrate 1 under the protective film 3.

Next, as illustrated in FIG. 2E, a resist layer 5A is formed on the protective film 3 by spin coating or the like. At chat time, the resist layer 5A can be embedded into the concave portions 1A and 1B. Further, a resist layer 5B is formed on the resist layer 5A in the mark region RB by using a photolithography technique.

Next, as illustrated in FIG. 2F, the resist layer 5A is etched with the resist layer 5B as a mask to expose the protective film 3 in the device region RA and remove the resist layer 5A in the concave portions 1A. Then, the concave portions 1A are etched with the resist layer 5A and the protective film 3 as masks to dig into the concave portions 1A and remove the ion-implanted layer 2A under the concave portions 1A.

Next, as illustrated in FIG. 2G, the resist layer 5A is thinned by ashing or the like to expose the protective film 3 in the mark region RB with the resist layer 5A still embedded in the concave portions 1B. Next, as illustrated in FIG. 2H, the protective film 3 is etched to remove the protective film 3 from the substrate 1. Next, as illustrated in FIG. 2I, the ion-implanted layer 2B is etched to remove the ion-implanted layer 2B from the substrate 1. Here, the alignment marks 2 can be protected by etching the ion-implanted layer 2B with the resist layer 5A left in the concave portions 1B. Next as illustrated in FIG. 2J, the resist layer 5A in the concave portions 1B is removed by ashing or the like.

Accordingly, the alignment marks 2 can be embedded only under the concave portions 1B to reduce variations in the alignment lights L1 between before and after the filling of the imprint material 12 into the concave portions 1B. In addition, the alignment marks 2 can be arranged in a self-aligning manner relative to the concave portions 1B. This makes it possible to form the alignment marks 2 separately from the concave portions 1A and 1B while maintaining the arrangement accuracy equal to that between the concave portions 1A and 1B.

### Third Embodiment

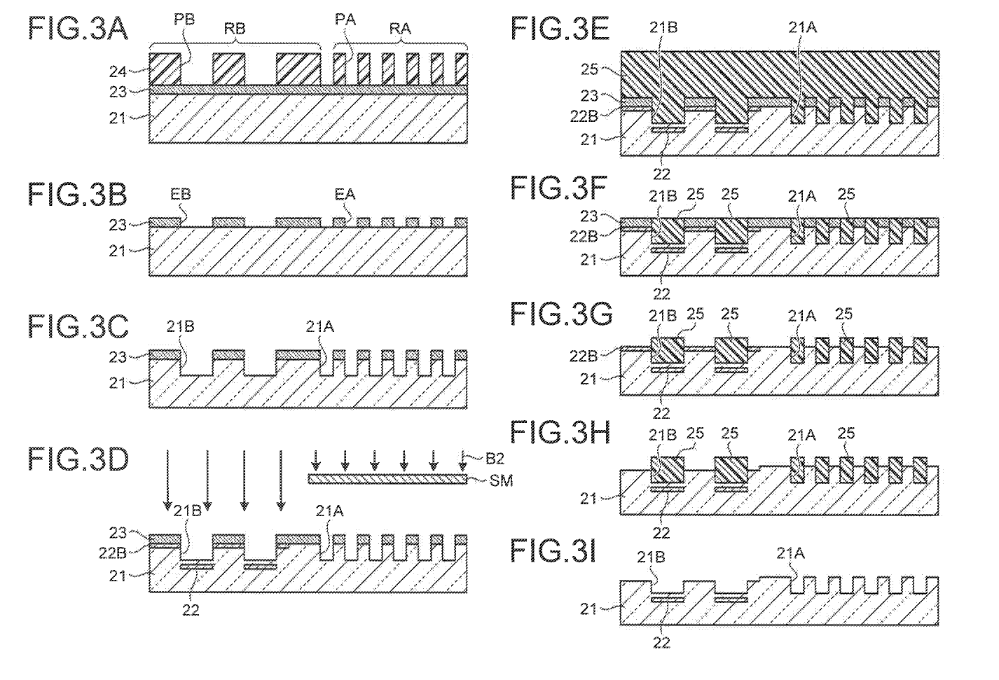

FIGS. 3A to 3I are cross-sectional diagrams illustrating a template manufacturing method according to a third embodiment.

Referring to FIG. 3A, a protective film 23 is formed on a substrate 21 by sputtering, CVD, or the like. Then, a resist pattern 24 is formed on the protective film 23 by using a photolithography technique. The resist pattern 24 can be provided with openings PA corresponding to the concave portions 21A and openings PB corresponding to the concave portions 21B.

Next, as illustrated in FIG. 3B, the protective film 23 is etched via the resist pattern 24 to transfer the resist pattern 24 to the protective film 23 and form on the protective film 23 openings EA and EB corresponding to the openings PA and PB, respectively.

Next, as illustrated in FIG. 3C, the substrate 21 is etched via the protective film 23 to form on the substrate 21 the concave portions 21A and 21B corresponding to the openings EA and EB, respectively.

Next, as illustrated in FIG. 3D, ion implantation B2 of antimony or the like is selectively performed in the mark region RB of the substrate 21 via a stencil mask SM to embed alignment marks 22 into the substrate 21 under the concave portions 21B. At that time, an ion-implanted layer 22B is formed on the surface of the substrate 21 under the protective film 23 in the mark region RB. The stencil mask SM can cover the device region RA on the substrate 21.

Next, as illustrated in FIG. 3E, a resist layer 25 is formed on the protective film 23 by spin coating or the like. At that time, the resist layer 25 can be embedded into the concave portions 21A and 21B.

Next, as illustrated in FIG. 3F, the resist layer 25 is thinned by ashing or the like to expose the protective film 23 with the resist layer 25 still embedded in the concave portions 21A and 21B. Next, as illustrated in FIG. 3G, the protective film 23 is etched to remove the protective film 23 from the substrate 21. Next, as illustrated in FIG. 3H, the ion-implanted layer 22B is etched to remove the ion-implanted layer 22B from, the substrate 21, Next as illustrated in FIG. 3I, the resist layer 25 in the concave portions 21A and 21B is removed by ashing or the like.

The stencil mask SM can be used here so as net to form an ion-implanted layer under the concave portions 21A. This eliminates the need for removing an ion-implanted layer under the concave portions 21A, thereby to reduce the number of steps as compared to the methods illustrated in FIGS. 2A to 2J.

### Fourth Embodiment

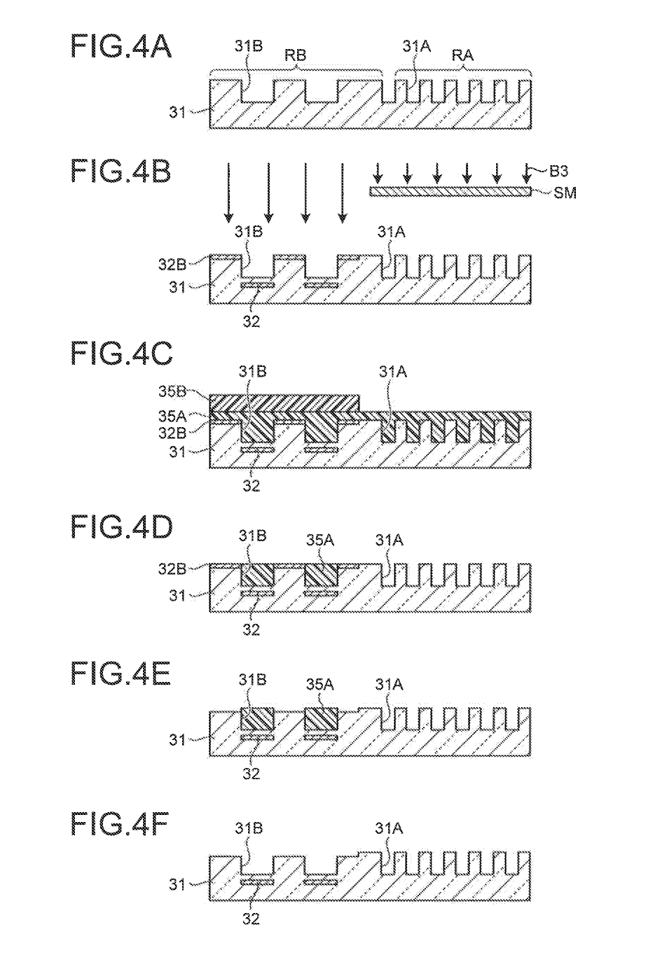

FIGS. 4A to 4F are cross-sectional diagrams illustrating a template manufacturing method according to a fourth embodiment.

Referring to FIG. 4A, a substrate 31 has concave portions 31A and 31B formed in advance. The concave portions 31A. are arranged in the device region FA and the concave portions 31B are arranged in the mark region RB.

Next, as illustrated in FIG. 4B, ion implantation B3 of antimony or the like is selectively performed in the mark region RB of the substrate 31 via the stencil mask SM to embed alignment marks 32 into the substrate 31 under the concave portions 31B. At that time, an ion-implanted layer 32B is formed on the surface of the substrate 31.

Next, as illustrated in FIG, 4C, a resist layer 35A is formed on the substrate 31 by spin coating or the like. At that time, the resist layer 35A can be embedded into the concave portions 31A and 31B. Further, a resist layer 35B is formed on the resist layer 35A in the mark region RB by using a photolithography technique. Next, as illustrated in FIG. 4D, the resist layers 35A and 35B are thinned by ashing or the like to expose the ion-implanted layer 32B with the resist layer 35A still embedded in the concave portions 31A and 31B and remove the resist layer 35A in the concave portions 31A. Next, as illustrated in FIG. 4E, the ion-implanted layer 32B is etched to remove the ion-implanted layer 32B from the substrate 31. Next, as illustrated in FIG. 4F, the resist layer 35A in the concave portions 31B is removed by ashing or the like.

Accordingly, the alignment marks 32 can be embedded only under the concave portions 31B even when the concave portions 31A and 31B are formed, in advance on the substrate 31.

### Fifth Embodiment

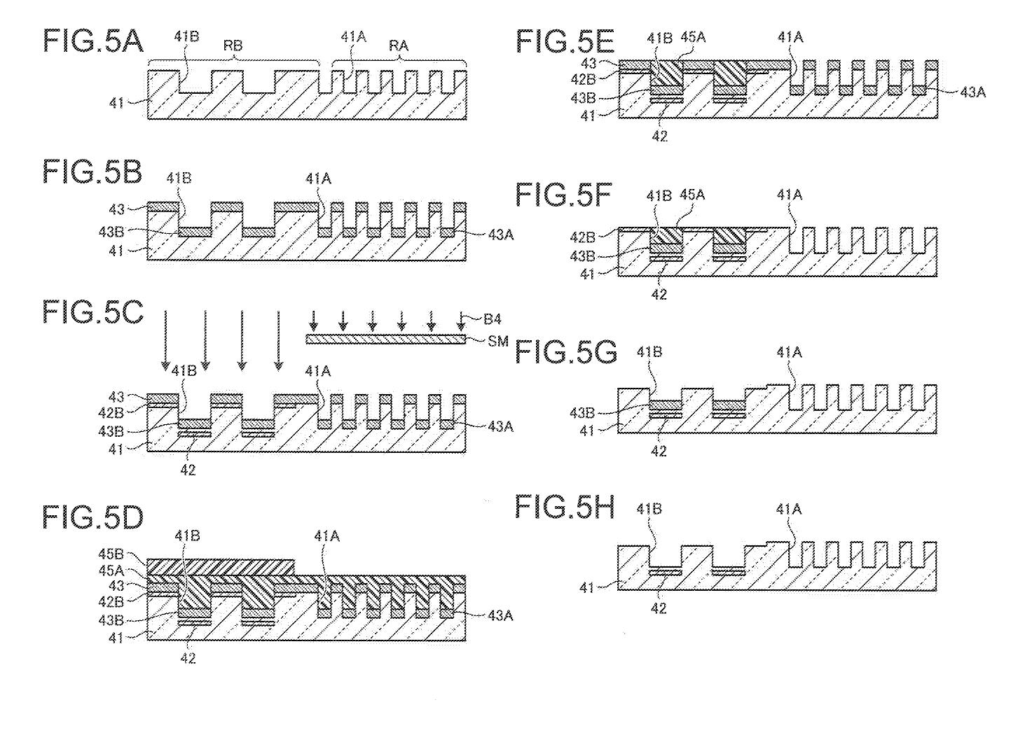

FIGS. 5A to 5H are cross-sectional diagrams illustrating a template manufacturing method according to a fifth embodiment.

Referring to FIG. 5A, a substrate 41 has concave portions 41A and 41B formed in advance. The concave portions 41A are arranged in the device region RA and the concave portions 41B are arranged in the mark region RB.

Next, as illustrated in FIG. 5B, a protective film 43 is formed on a substrate 41 by sputtering, CVD, or the like. At that time, a protective film 43A is formed on bottom surfaces of the concave portions 41A, and a protective film 43B is formed on bottom, surfaces of the concave portions 41B.

Next, as illustrated in FIG. 5C, ion implantation B4 of antimony or the like is selectively performed in the mark region RB of the substrate 41 via the stencil mask SM to embed alignment marks 42 into the substrate 41 under the concave portions 41B. At that time, an ion-implanted layer 42B is formed on the surface of the substrate 41 under the protective film 43 in the mark region RB.

Next, as illustrated in FIG. 5D, a resist layer 45A is formed on the substrate 41 by spin coating or the like. At that time, the resist layer 45A can be embedded into the concave portions 41A and 41B. Further, a resist layer 45B is formed on the resist layer 45A in the mark region RB by using a photolithography technique. Next, as illustrated in FIG. 5E, the resist layers 45A and 45B are thinned by ashing or the like to expose the protective film 43 with the resist layer 45A still embedded in the concave portions 41B and remove the resist layer 45A in the concave portions 41A. Next, as illustrated in FIG. 5F, the protective films 43 and 43A are etched to remove the protective films 43 and 43A from the substrate 41. Next, as illustrated, in FIG. 5G, the ion-implanted layer 423 is etched to remove the ion-implanted, layer 42B from the substrate 41. After that, the resist layer 45A in the concave portions 41B is removed by ashing or the like, Next, as illustrated in FIG. 5H, the protective film 43B is etched to remove the protective film 43B from the substrate 41.

Accordingly, even when the concave portions 41A and 41B are formed in advance in the substrate 41, the alignment marks 42 can be embedded only under the concave portions 41B while protecting the substrate 41 by the protective film 43.

### Sixth Embodiment

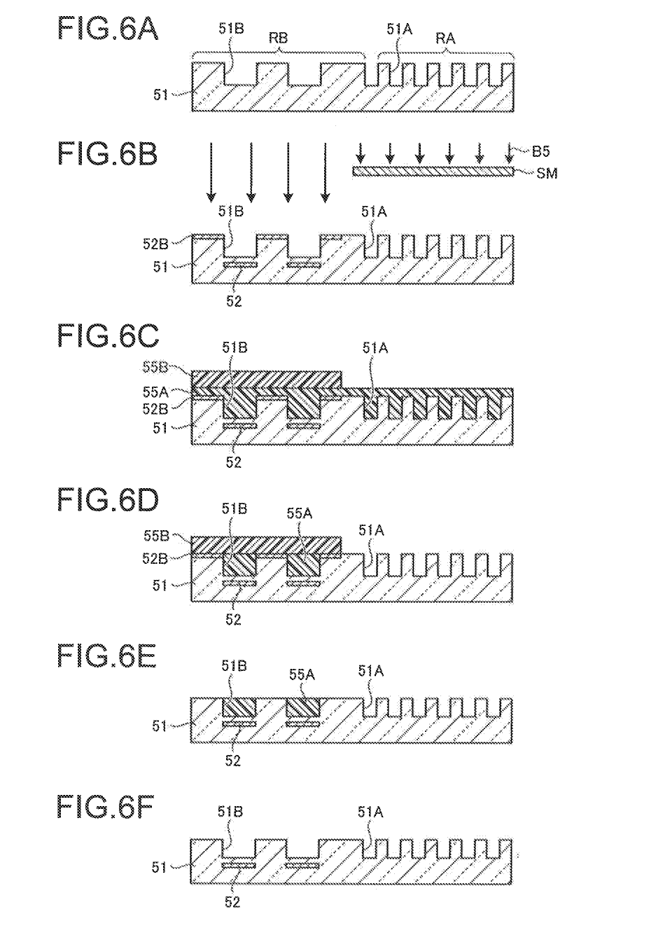

FIGS. 6A to 6F are cross-sectional diagrams illustrating a template manufacturing method according to a sixth embodiment.

Referring to FIG. 6A, a substrate 51 has concave portions 51A and 51B formed in advance. The concave portions 51A are arranged in the device region RA and the concave portions 51B are arranged in the mark region RB.

Next, as illustrated in FIG. 6B, ion implantation B5 of antimony or the like is selectively performed in the mark region RB of the substrate 51 via the stencil mask SM to embed alignment marks 52 into the substrate 51 under the concave portions 51B. At that time, an ion-implanted layer 52B is formed on the surface of the substrate 51.

Next, as illustrated in FIG. 6C, a resist layer 55A is formed on the substrate 51 by spin coating or the like. At that time, the resist layer 55A can be embedded into the concave portions 51A and 51B. Further, a resist layer 55B is formed on the resist layer 55A in the mark region RB by using a photolithography technique. Next, as illustrated in FIG. 6D, the resist layer 55A in the device region RA is removed by etching or the like. Next, as illustrated in FIG. 6E, the substrate 51 is thinned by CMP to remove the ion-implanted layer 52B from the substrate 51. Next, as illustrated in FIG. 5F, the resist layer 55A in the concave portions 51B is removed by ashing or the like.

Accordingly, even when the concave portions 51A and 51B are formed in advance in the substrate 51, the alignment marks 52 can be embedded only under the concave portions 51B. If the alignment marks 52 are not removed at removal of the ion-implanted layer 52B by CMP, the steps illustrated in FIGS. 6C to 6E may be omitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall, within the scope and spirit of the inventions.

What is claimed is:

1. A template, comprising:
a pattern region for a device and a mark region provided on one and the same surface of a substrate;
a first concave portion provided in the pattern region;
a second concave portion provided in the mark region; and
an alignment mark that is embedded in a position opposed to a bottom surface of the second concave portion in the substrate.

2. The template according to claim 1, wherein the alignment mark corresponds in shape and size to the bottom surface of the second concave portion.

3. The template according to claim 1, wherein the alignment mark is embedded in a position unexposed from the substrate.

4. The template according to claim 1, wherein the substrate is a transparent substrate and the alignment mark is a light-absorbing layer.

5. The template according to claim 4, wherein the alignment mark is an ion-implanted layer.

6. The template according to claim 1, wherein the first concave portion is made finer than the second concave portion.

7. The template according to claim 1, wherein the first, concave portion is equal in depth to the second concave port ion.

8. The template according to claim 1, wherein the first concave portion is deeper than the second concave portion.

9. A template manufacturing method, comprising:
forming a first concave portion in a device region of a substrate and forming a second concave portion in a mark region of the substrate and;
embedding an alignment mark in a position arranged under the second concave portion in the substrate by ion implantation.

10. The template manufacturing method according to claim 9, comprising:
embedding a resist film in the second concave portion;
digging into the first concave portion to remove an ion-implanted layer embedded in a position arranged under the first concave portion in the substrate by the ion implantation; and
removing an ion-implanted layer formed on a surface of the substrate at the ion implantation.

11. The template manufacturing method according to claim 10, wherein the ion implantation is performed via a stencil mask covering the device region.

12. The template manufacturing method according to claim 11, comprising:
removing an ion-implanted layer formed on. a surface of the substrate in the mark region at the ion implantation.

13. An imprinting method, comprising:
forming an imprint material on a processed layer;
identifying a position of the template by referring to an alignment, mark provided on the template while one template is pressed against the imprint material;
forming an imprint pattern on the processed layer by transferring a template pattern provided on the template to the imprint material and;
forming a processed pattern on the processed layer by transferring the imprint pattern to the processed layer, wherein
the template includes:
a pattern region for a device and a mark region provided on one and the same surface of a substrate;
a first concave portion provided in the pattern region; and
a second concave portion provided in the mark region, and
the alignment mark is embedded in a position opposed to a bottom surface of the second concave portion in the substrate.

14. The imprinting method according to claim 13, wherein an alignment light from the alignment mark is detected to identify the position of the template.

15. The template according to claim. 13, wherein the alignment mark corresponds in shape and size to the bottom surface of the second concave portion.

16. The template according to claim 13, wherein the alignment mark is embedded in a position unexposed from the substrate.

17. The template according to claim 13, wherein the substrate is a transparent substrate and the alignment mark, is a light-absorbing layer.

18. The template according to claim 17, wherein the alignment mark is an ion-implanted layer.

19. The template according to claim 13, wherein the first concave portion is made finer than the second concave portion.

20. The template according to claim 19, wherein the width of the first concave portion and the space between the same are set in nanometer order.
